(19) United States
(12) Patent Application Publication
(10) Pub. No.: US 2025/0180897 A1
(43) Pub. Date: Jun. 5, 2025

(54) HYBRID MODULATION METHOD AND SYSTEM

(71) Applicant: SHANGHAI JIAOTONG UNIVERSITY, Minhang District Shanghai (CN)

(72) Inventors: Jiangang Lu, Minhang District Shanghai (CN); Yuxiang Luo, Minhang District Shanghai (CN); Kai Huang, Minhang District Shanghai (CN)

(21) Appl. No.: 17/756,076

(22) PCT Filed: Nov. 5, 2021
(86) PCT No.: PCT/CN2021/129003

§ 371 Date: Feb. 15, 2024

(30) Foreign Application Priority Data
Nov. 16, 2020 (CN) 202011277719.1

(51) Int. Cl. G02B 27/00; G02B 6/293; G02B 27/42

(52) U.S. Cl. CPC G02B 27/0012; G02B 6/29304; G02B 27/4233

(57) ABSTRACT

A hybrid modulation method and system is provided. The method includes the following steps: establishing a simulation model of a spatial light modulator; obtaining, by the simulation model, a phase modulation depth of a phase modulation performed by a blazed grating at each communication port, where within a phase modulation range, when light output from a zero^{th} communication port is diffracted into a k^{th} target communication port, the simulation model obtains diffraction efficiencies of various orders at different phase modulation depths, a phase modulation depth Aₖπ corresponding to a highest isolation is selected as a phase modulation depth of the k^{th} communication port, where k∈(0, K); and performing a phase modulation depth Aₖπ on light that is output from the zero^{th} communication port of a communication fiber and that is to be diffracted into the k^{th} target communication port.

### CROSS REFERENCE TO RELATED APPLICATION(S)

This application is a national stage of International Application No. PCT/CN2021/129003, filed on Nov. 5, 2021, which claims priority to the Chinese Patent Application No. 202011277719.1, filed with the China National Intellectual Property Administration (CNIPA) on Nov. 16, 2020, and entitled “HYBRID MODULATION METHOD AND SYSTEM”. Both of the aforementioned applications are incorporated herein by reference in their entireties.

### TECHNICAL FIELD

The present disclosure relates to the field of spatial light modulation technologies, and in particular, to a hybrid modulation method and system.

### BACKGROUND ART

In recent years, with continuous development of optical communication, requirements of a communication system on a communication component are gradually improved, especially a wavelength selective switch as a core module in an optical communication system. A core component of the wavelength selective switch is a spatial light modulator. Modulators commonly used are micro-electro-mechanical system (MEMS) components. However, the MEMS components are not flexible enough to meet requirements of existing communication technologies. With gradual development of a liquid crystal on silicon device, the liquid crystal on silicon device is deemed as one of important substitutes for a next-generation spatial light modulator, due to its many advantages, such as relatively high diffraction efficiency, high resolution, high refresh rate, high flexibility and high integration, and its beam modulation function. However, when a current liquid crystal on silicon device is applied to the wavelength selective switch, there are also some disadvantages. For example, diffraction efficiency of the liquid crystal on silicon device is not high enough, and isolation between fiber ports is not enough. These disadvantages prevent the liquid crystal on silicon device from being commercially produced on a large scale.

### SUMMARY

In view of this, the present disclosure aims to provide a hybrid modulation method and system, which can improve diffraction efficiency by increasing an isolation between fiber ports, thereby improving a transmission rate of an optical communication network.

To achieve the above object, the present disclosure provides the following solutions:

A hybrid modulation method is provided, including the following steps:
setting a phase modulation range;
establishing a simulation model of a spatial light modulator;
obtaining, by the simulation model, a phase modulation depth of a phase modulation performed by a blazed grating at each communication port, where a zero^{th} communication port is an output port, target communication ports of the blazed grating include a first communication port, . . . , a k^{th} communication port, . . . , and a K^{th} communication port, K is a maximum number; within the phase modulation range, when light is diffracted into the k^{th} communication port, the simulation model obtains diffraction efficiencies of various orders at different phase modulation depths, isolations of the k^{th} communication port are calculated based on the diffraction efficiencies, a phase modulation depth Aₖπ corresponding to a highest isolation is selected as a phase modulation depth of the k^{th} communication port, where k∈(0, K); and
performing a phase modulation with phase modulation depth Aₖπ on light that is output from the zero^{th} communication port of a communication fiber and that is to be diffracted into the k^{th} communication port.

In some embodiments, the simulation model of the spatial light modulator is established based on Virtual Lab Fusion.

In some embodiments, the spatial light modulator performs a phase modulation with phase modulation depth Aₖπ on light that is output from the zero^{th} communication port and is to be diffracted into the k^{th} communication port.

In some embodiments, the spatial light modulator is a liquid crystal on silicon spatial light modulator.

The present disclosure further discloses a hybrid modulation system, and the hybrid modulation method is applied to the hybrid modulation system.

The hybrid modulation system includes a communication fiber, a first lens, a transmission grating, a second lens, and a spatial light modulator that are sequentially disposed.

In some embodiments, the first lens is a collimating lens.

In some embodiments, the second lens is a cylindrical lens.

In some embodiments, the spatial light modulator is a liquid crystal on silicon spatial light modulator.

According to the specific embodiments provided by the present disclosure, the present disclosure discloses the following technical effects:

The present disclosure discloses a hybrid modulation method and system. Alternating modulation is performed with different modulation depths at communication ports at a middle part of the communication port array, so that crosstalk among the communication ports is reduced, and isolations of the communication ports are improved, thereby improving a transmission rate of an optical communication network.

### BRIEF DESCRIPTION OF THE DRAWINGS

To describe the technical solutions in the embodiments of the present disclosure or in the prior art more clearly, the accompanying drawings required for the embodiments are briefly described below. Apparently, the accompanying drawings in the following descriptions show merely some embodiments of the present disclosure, and those of ordinary skills in the art may still derive other accompanying drawings from these accompanying drawings without creative efforts.

FIG. 1 is a schematic flowchart of a hybrid modulation method according to the present disclosure;

FIG. 2 is an optical path diagram of an apparatus for performing phase modulation with modulation depth of 6π at a second communication port according to the present disclosure;

FIG. 3 is an optical path diagram of an apparatus for performing phase modulation with modulation depth of 4π at a third communication port according to the present disclosure; and

FIG. 4 is a schematic structural diagram of a hybrid modulation system according to the present disclosure.

### DETAILED DESCRIPTION OF THE EMBODIMENTS

The technical solutions in the embodiments of the present disclosure will be described below clearly and completely with reference to the accompanying drawings in the embodiments of the present disclosure. Apparently, the described embodiments are merely some rather than all of the embodiments of the present disclosure. All other embodiments obtained by a person of ordinary skills in the art based on the embodiments of the present disclosure without creative efforts shall fall within the protection scope of the present disclosure.

The present disclosure aims to provide a hybrid modulation method and system, which improve diffraction efficiency by increasing isolation between fiber ports, thereby improving a transmission rate of an optical communication network.

To make the above-mentioned object, features, and advantages of the present disclosure clearer and more comprehensible, the present disclosure will be further described in detail below in conjunction with the accompanying drawings and specific embodiments.

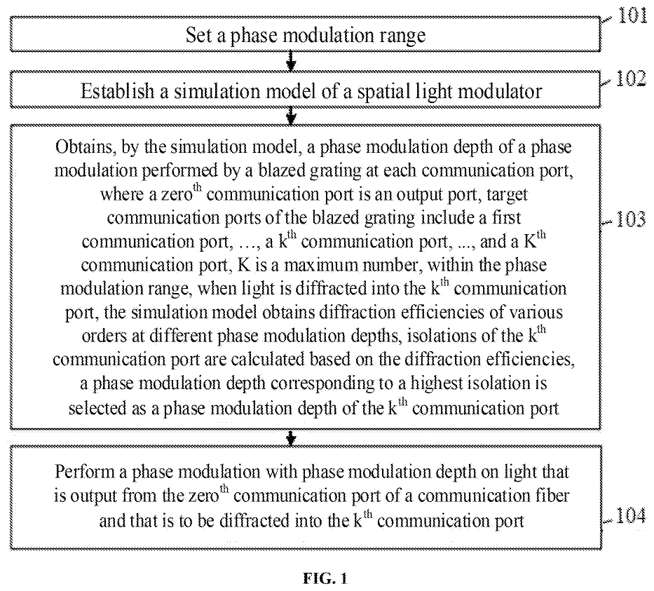

FIG. 1 is a schematic flowchart of a hybrid modulation method according to the present disclosure. As shown in FIG. 1, the hybrid modulation method includes the following steps.

In step 101, a range for phase modulation is set.

In step 102, a simulation model of a spatial light modulator is established.

In step 103, a modulation depth of phase modulation by a blazed grating for each communication port is obtained by the simulation model, where a zero^{th} port is an output port, target communication ports of the blazed grating are a first communication port, . . . , a k^{th} communication port, . . . , and a K^{th} communication port in order, K is a maximum number. Within the range for phase modulation, when light is diffracted into the k^{th} communication port, diffraction efficiencies for various orders at different phase modulation depths are obtained by the simulation model. Isolations of the k^{th} communication port are calculated based on the diffraction efficiencies, a phase modulation depth Aₖπ corresponding to the highest isolation is selected as a phase modulation depth of the k^{th} communication port, and k∈(0, K).

In step 104, phase modulation with the modulation depth Aₖπ is performed on light that is output from the zero^{th} port of a communication fiber and that is to be diffracted into the k^{th} communication port.

In above step 103, the simulation model of the spatial light modulator is established by Virtual Lab Fusion. The isolation is a ratio of an intensity of an incident light into a target port to an intensity of an incident light into any other port, and generally, a logarithm of the ratio is obtained. An equation for calculating the isolation is as follows:

$$q = 10 log \frac{{I}_{k}}{{I}_{j}} ,$$

where q indicates an isolation between a k^{th} communication port and a jth communication port, and j≠k, Iₖ is an intensity of an incident light into the k^{th} communication port, and Iⱼ is an intensity of an incident light into the jth communication port.

In step 104, phase modulation with the modulation depth Aₖπ is performed by the spatial light modulator on the light that is output from the zero^{th} port and is to be diffracted into the k^{th} communication port.

The spatial light modulator is a liquid crystal on silicon spatial light modulator.

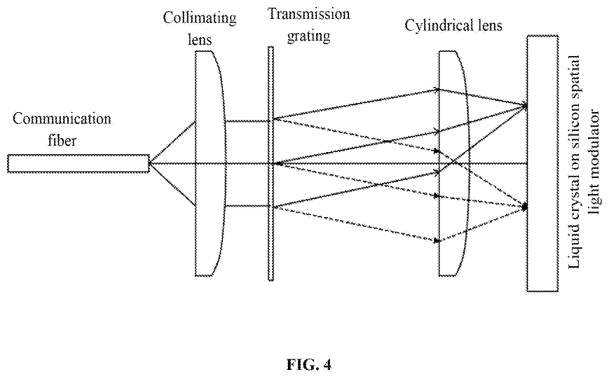

As shown in FIG. 4, the present disclosure further discloses a hybrid modulation system, and the hybrid modulation method is applied to the hybrid modulation system.

The hybrid modulation system includes a communication fiber, a collimating lens, a transmission grating, a cylindrical lens, and a liquid crystal on silicon spatial light modulator that are sequentially disposed.

In the present disclosure, the hybrid modulation method is used to gate a communication port, so as to improve port isolation and diffraction efficiency of a wavelength selective switch module. Further, the method is simple.

Compared with phase modulation with modulation depth of 2π, the present disclosure may use modulation depths of 2π, 4π, 6π, and others, and perform slight adjustment based on these modulation depths. It is assumed that 11 ports are arranged at equal angle intervals, and are respectively denoted as 0 to 10. A zero^{th} port is an incident port, and ports denoted as 1 to 10 are target ports for light deflection. For example, when the phase modulation depth of 4π is used, energy is collected at a second diffraction order. If a target port in this case is a fifth port, the energy at a fourth diffraction order is diffracted into a 10^{th} port, and the energy at a first diffraction order and a third diffraction order are not diffracted into any port. If too much energy is diffracted into the 10^{th} port, a phase modulation depth may be slightly adjusted based on the modulation depth of 4π in a manner of adding or subtracting, so that energy at the fourth diffraction order is transferred to other orders. Thereby, isolation is optimized.

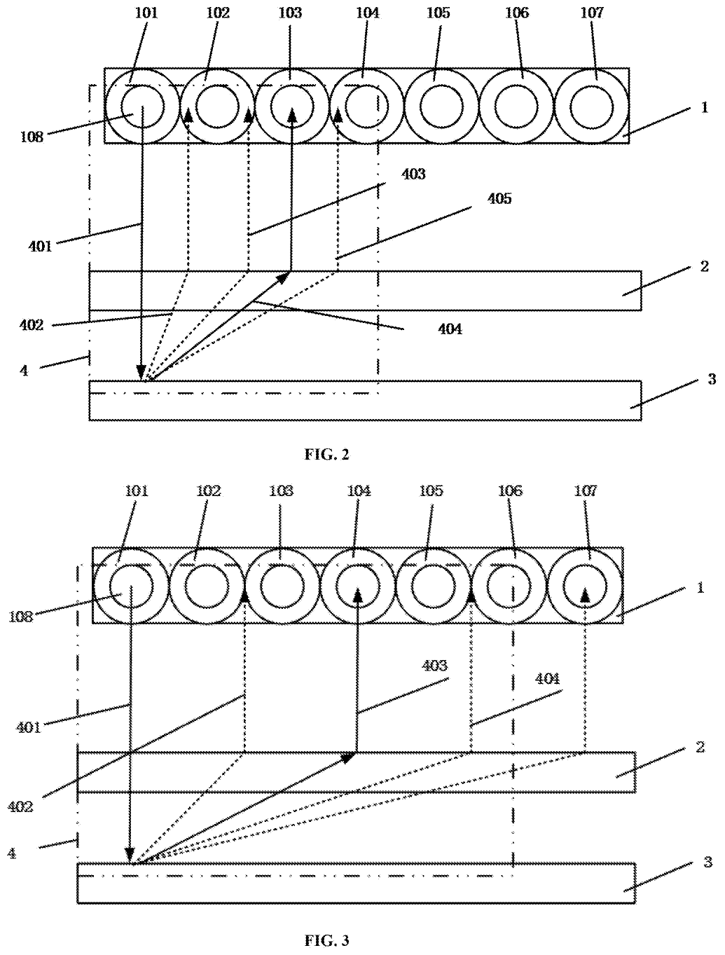

FIG. 2 is an optical path diagram of an apparatus for performing phase modulation with modulation depth 6π on a second communication port according to the present disclosure. As shown in FIG. 2, the apparatus includes a communication port array 1, a lens 2, and a spatial light modulator 3 in order from top to bottom. The communication port array 1 includes a zero^{th} communication port 101, a first communication port 102, a second communication port 103, a third communication port 104, a fourth communication port 105, a fifth communication port 106, and a sixth communication port 107 in order from left to right. Each communication port includes a communication port core 108. During communication, an optical path 4 includes an incident light signal 401, a first-order diffracted light beam 402, a second-order diffracted light beam 403, a third-order diffracted light beam 404, and a fourth-order diffracted light beam 405. When phase modulation with modulation depth of 6π is performed at the second communication port 103, the incident light signal 401 is emitted from the zero^{th} communication port 101, first passes through a center of the lens 2, and falls on the spatial light modulator 3. Further, a landing point of the incident light signal 101 on the spatial light modulator 3 is exactly located at a focus of the lens 2. After the incident light signal 101 is modulated by the spatial light modulator 3, the incident light signal 101 is divided into multiple-order diffracted light signals, including the first-order diffracted light beam 402, the second-order diffracted light beam 403, the third-order diffracted light beam 404, and the fourth-order diffracted light beam 405. A zero^{th}-order diffracted light is not illustrated, which returns to the zero^{th} communication port 101 along the path of the incident light signal 401. There are also many other higher-order diffracted light beams, which however have very low energy, and are not illustrated. Only several representative diffracted light beams are drawn. The third-order diffracted light 404 has a highest energy, and falls on the communication port core 108 of the gated second communication port 103. The first-order diffracted light 402 may fall between the communication port core 108 of the zero^{th} communication port 101 and the communication port core 108 of the first communication port 102. The second-order diffracted light 403 may fall between the communication port core 108 of the first communication port 102 and the communication port core 108 of the second communication port 103. The fourth-order diffracted light 405 may fall between the communication port core 108 of the second communication port 103 and the communication port core 108 of the third communication port 104. Except that a target-order diffracted light energy falls on the communication port core 108 of target communication port, any other order diffracted light energy does not hit the communication port core 108. This greatly reduces crosstalk among communication ports and improves isolations of ports.

FIG. 3 is an optical path diagram of an apparatus for performing phase modulation with modulation depth of 4π on a third communication port according to the present disclosure. As shown in FIG. 3, the apparatus includes a communication port array 1, a lens 2, and a spatial light modulator 3 in order from top to bottom. The communication port array 1 includes a zero^{th} communication port 101, a first communication port 102, a second communication port 103, a third communication port 104, a fourth communication port 105, a fifth communication port 106, and a sixth communication port 107 in order from left to right. Each communication port includes a communication port core 108. During communication, an optical path 4 includes an incident light signal 401, a first-order diffracted light beam 402, a second-order diffracted light beam 403, and a third-order diffracted light beam 404. When phase modulation with modulation depth of 4π is performed at the third communication port 104, the incident light signal 401 may be emitted from the zero^{th} communication port 101, first pass through a center of the lens 2, and falls on the spatial light modulator 3. Further, a landing point of the incident light signal 101 on the spatial light modulator 3 is exactly located at a focus of the lens 2. After being modulated by the spatial light modulator 3, the incident light signal 101 is divided into multiple-order diffracted light signals, including the first-order diffracted light beam 402, the second-order diffracted light beam 403, and the third-order diffracted light beam 404. A zero^{th}-order diffracted light is not illustrated, which returns to the zero^{th} communication port 101 along the path of the incident light signal 401. There are also many other higher-order diffracted light beams, which however have very low energy, and are not illustrated. Only several representative diffracted light beams are drawn. The second-order diffracted light 403 has a highest energy, and falls on the communication port core 108 of the gated third communication port 104. The first-order diffracted light 402 may fall between the communication port core 108 of the first communication port 102 and the communication port core 108 of the second communication port 103. The third-order diffracted light 404 may fall between the communication port core 108 of the fourth communication port 105 and the communication port core 108 of the fifth communication port 106. Except that energy of a target-order diffracted light falls on the communication port core 108 of target communication port, energy of any other order diffracted light does not hit the communication port core 108. This greatly reduces crosstalk between communication ports and improves port isolation.

Each embodiment of this specification is described in a progressive manner, each embodiment focuses on the differences from other embodiments, and the same and similar parts between the embodiments may refer to each other.

In this specification, some specific embodiments are used for illustration of the principles and implementations of the present disclosure. The description of the foregoing embodiments is only used to help illustrate the method of the present disclosure and the core ideas thereof. In addition, persons of ordinary skills in the art can make various modifications in terms of specific implementations and the scope of application in accordance with the ideas of the present disclosure. In conclusion, the content of this specification shall not be construed as a limitation to the present disclosure.

1. A hybrid modulation method, comprising:
setting a phase modulation range;
establishing a simulation model of a spatial light modulator;
obtaining, by the simulation model, a phase modulation depth of a phase modulation performed by a blazed grating at each communication port, wherein a zero^{th} communication port is an output port, target communication ports of the blazed grating comprise a first communication port, . . . , a k^{th} communication port, . . . , and a K^{th} communication port, K is a maximum number; within the phase modulation range, when light is diffracted into the k^{th} communication port, the simulation model obtains diffraction efficiencies of various orders at different phase modulation depths, isolations of the k^{th} communication port are calculated based on the diffraction efficiencies, a phase modulation depth Aₖπ corresponding to a highest isolation is selected as a phase modulation depth of the k^{th} communication port, wherein k∈(0, K); and
performing a phase modulation with phase modulation depth Aₖπ on light that is output from the zero^{th} communication port of a communication fiber and that is to be diffracted into the k^{th} communication port.

2. The hybrid modulation method according to claim 1, wherein the simulation model of the spatial light modulator is established based on Virtual Lab Fusion.

3. The hybrid modulation method according to claim 1, wherein the performing a phase modulation with phase modulation depth Aₖπ on light that is output from the zero^{th} communication port and is to be diffracted into the k^{th} communication port is implemented by the spatial light modulator.

4. The hybrid modulation method according to claim 3, wherein the spatial light modulator is a liquid crystal on silicon spatial light modulator.

5. A hybrid modulation system, to which the hybrid modulation method according to claim 1 is applied, comprising:
a communication fiber, a first lens, a transmission grating, a second lens, and a spatial light modulator that are sequentially disposed.

6. The hybrid modulation system according to claim 5, wherein the first lens is a collimating lens.

7. The hybrid modulation system according to claim 5, wherein the second lens is a cylindrical lens.

8. The hybrid modulation system according to claim 5, wherein the spatial light modulator is a liquid crystal on silicon spatial light modulator.

9. A hybrid modulation system, to which the hybrid modulation method according to claim 2 is applied, comprising:
a communication fiber, a first lens, a transmission grating, a second lens, and a spatial light modulator that are sequentially disposed.

10. The hybrid modulation system according to claim 9, wherein the first lens is a collimating lens.

11. The hybrid modulation system according to claim 9, wherein the second lens is a cylindrical lens.

12. The hybrid modulation system according to claim 9, wherein the spatial light modulator is a liquid crystal on silicon spatial light modulator.

13. A hybrid modulation system, to which the hybrid modulation method according to claim 3 is applied, comprising:
a communication fiber, a first lens, a transmission grating, a second lens, and a spatial light modulator that are sequentially disposed.

14. The hybrid modulation system according to claim 13, wherein the first lens is a collimating lens.

15. The hybrid modulation system according to claim 13, wherein the second lens is a cylindrical lens.

16. The hybrid modulation system according to claim 13, wherein the spatial light modulator is a liquid crystal on silicon spatial light modulator.

17. A hybrid modulation system, to which the hybrid modulation method according to claim 4 is applied, comprising:
a communication fiber, a first lens, a transmission grating, a second lens, and a spatial light modulator that are sequentially disposed.

18. The hybrid modulation system according to claim 17, wherein the first lens is a collimating lens.

19. The hybrid modulation system according to claim 17, wherein the second lens is a cylindrical lens.

20. The hybrid modulation system according to claim 17, wherein the spatial light modulator is a liquid crystal on silicon spatial light modulator.
